(19) United States
(12) Patent Application Publication
(10) Pub. No.: US 2025/0286653 A1
(43) Pub. Date: Sep. 11, 2025

(54) WIRELESS UNEQUAL MODULATION

(71) Applicant: MaxLinear, Inc., Carlsbad, CA (US)

(72) Inventors: Rainer Strobel, München (DE); Sigurd Schelstraete, Menlo Park, CA (US); Avi Avraham Mansour, Givat-Shmuel (IL); Ziv Avital, Kadima (IL)

(73) Assignee: MaxLinear, Inc., Carlsbad, CA (US)

(21) Appl. No.: 19/075,739

(22) Filed: Mar. 10, 2025

Related U.S. Application Data
(60) Provisional application No. 63/563,204, filed on Mar. 8, 2024.

(51) Int. Cl. H04L 1/00; H04L 27/34

(52) U.S. Cl. CPC H04L 1/0058; H04L 1/007; H04L 27/3411

(57) ABSTRACT

An access point (AP) may include a processing device. The processing device may determine, at the AP, one or more unequal modulation settings. The processing device may identify, at the AP, a forward error correction (FEC) code rate for a plurality of spatial streams based on the one or more unequal modulation settings. The processing device may compute, at the AP, one or more constellation sizes for the plurality of spatial streams for transmission to a station (STA) based on the one or more unequal modulation settings.

### RELATED APPLICATION

This application claims the benefit of U.S. Provisional Application No. 63/563,204, filed Mar. 8, 2024, the disclosure of which is incorporated herein by reference in its entirety for all purposes.

The examples discussed in the present disclosure are related to wireless local area networks.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11 g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

An access point (AP) may include a processing device. The processing device may determine, at the AP, one or more unequal modulation settings. The processing device may identify, at the AP, a forward error correction (FEC) code rate for a plurality of spatial streams based on the one or more unequal modulation settings. The processing device may compute, at the AP, one or more constellation sizes for the plurality of spatial streams for transmission to a station (STA) based on the one or more unequal modulation settings.

A STA may include a processing device. The processing device may compute, at the STA, one or more SNR margins for one or more spatial streams. The processing device may send, from the STA to an AP, the SNR margins for the one or more spatial streams.

A method may include one or more of: computing, at the AP, a forward error correction (FEC) code rate in which the FEC code rate is 2/3; computing, at the AP, a constellation size in which the constellation size is one or more of 1 bit, 2 bits, 4 bits, 8 bits, 10 bits, or 12 bits; and/or transmitting, from the AP to a STA, a transmission using the FEC code rate and the constellation size.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example wireless local area network access point (AP) and station (STA) with 4 antennas.

FIG. 2 illustrates an example graph for signal-to-noise ratio (SNR) per spatial stream and carrier group (16 carriers) for an example channel.

FIG. 3 illustrates an example graph for physical layer (PHY) rate and medium access control (MAC) throughput over SNR with 2 spatial streams.

FIG. 4 illustrates an example graph for 3 bit diamond-shaped constellations.

FIG. 5 illustrates an example graph for dependency between capacity and SNR for wireless local area network (WLAN) quadrature amplitude modulation (QAM) constellations.

FIG. 6 illustrates an example graph for dependency between generalized mutual information (GMI) in bits and bit error ratio for different WLAN low density parity check (LDPC) code rates.

FIG. 7A illustrates an example process flow for a procedure to select constellation size and code rate from SNR.

FIG. 7B illustrates an example process flow for a procedure to find the code rates and constellation sizes with respect to best effective throughput.

FIG. 8 illustrates an example process flow for a packet error rate-based SNR margin control.

FIG. 9A illustrates an example graph for coded bit error rate (BER) vs. raw BER for 4-QAM with LDPC rate 3/4 (MCS2) and 16-QAM and LDPC rate 3/4 (MCS4).

FIG. 9B illustrates an example graph for SNR vs. raw BER for 4-QAM with LDPC rate 3/4 (MCS2) and 16-QAM and LDPC rate 3/4 (MCS4).

FIG. 10A illustrates an example graph for dependency between GMI and raw BER and coded BER for 4-QAM with LDPC rate 3/4 (MCS2) and 16-QAM and LDPC rate 3/4 (MCS4).

FIG. 10B illustrates dependency between SNR and GMI for 4-QAM with LDPC rate 3/4 (MCS2) and 16-QAM and LDPC rate 3/4 (MCS4).

FIG. 11 illustrates beamformed transmission with unequal modulation.

FIG. 12 illustrates a block diagram of an example system operable to perform wireless unequal modulation.

FIG. 13 illustrates an example process flow for wireless unequal modulation.

FIG. 14 illustrates an example process flow for wireless unequal modulation.

FIG. 15 illustrates an example process flow for wireless unequal modulation.

FIG. 16 illustrates a diagrammatic representation of a machine in the example form of a computing device within which a set of instructions, for causing the machine to perform any one or more of the methods discussed herein, may be executed.

FIG. 17A illustrates example graphs for BER vs. channel SNR for unequal constellation and equal constellation size per spatial stream.

FIG. 17B illustrates examples graphs of the SNR of spatial streams.

FIG. 18 illustrates an example graph for required SNR for equal and unequal modulation with different SNR differences.

FIG. 19 illustrates an example graph for rate vs. reach curve for equal modulation vs. unequal modulation rate vs. range curve.

### DESCRIPTION

Wireless local area network (WLAN) devices may be equipped with multiple antennas and use beamforming or multi-user multiple input multiple output (MIMO) precoding to create a connection with multiple spatial streams between the access point (AP) and the station (STA).

MIMO transmission in WLAN may have limited capability to adjust the modulation and coding settings to the channel conditions. WLAN clients may be mostly stationary or slowly moving and thus, the channel conditions may be estimated with precision to adjust the transmission settings.

WLAN may have increased bandwidth available and the capability to send multiple spatial streams per link. For multiple spatial streams sent to one STA, there may be a link quality difference between the spatial streams due to the singular value decomposition (SVD)-based method, which may be used to perform MIMO transmission with beamforming.

Wireless LANs abilities to adjust modulation and coding scheme (MCS) settings to the channel conditions may be limited. The reasons for limiting MCS settings may be: (i) complexity associated with finding the appropriate MCS setting (link adaptation), (ii) complexity of the modulation and demodulation hardware, and/or (iii) communication overhead associated with communication of the MCS settings and measurements to find the MCS setting.

In some examples, WLAN may allow a small number of MCS settings, which may define constellation size and FEC code rate. The same MCS may be used for carriers and spatial streams of a single connection. Signal-to-noise ratio (SNR) differences between spatial streams and carriers may not be taken into account.

Link adaptation may be based on a trial and error based method, testing relevant MCS and spatial stream settings and observing the packet error rate. Increasing the number of possible MCS settings may cause the number of settings to test to increase massively. Currently, low density parity check (LDPC) code rate and quadrature amplitude modulation (QAM) constellation size settings may be coupled and assigned to a certain MCS index. 802.11be WLAN supports 14 MCS settings 0, . . . , 13, built from 4 LDPC code rates 1/2, 2/3, 3/4, 5/6 and 7 QAM constellations of 1, 2, 4, 6, 8, 10 and 12 bit.

Adjustments of the modulation and coding scheme per spatial stream and frequency may be performed such that there may be an efficient method to derive the modulation and coding settings with minimal impact on the modulation and coding hardware. To keep the impact on the modulation/demodulation hardware small, a single LDPC setting (code rate) may be used for a link, while the same QAM constellation may not be used.

In one example, the available combinations of LDPC and QAM constellation may not be changed. Thus, MCS with the same LDPC code rate may be used on a single link and the MCS may remain the same. In another example, a few additional LDPC code rate and QAM constellation combinations may be used. For the LDPC code rate setting, there may be a range of QAM constellation sizes to be allowed to be used with the specific code rate. In another example, additional QAM constellation sizes may be added to allow a more fine-grained adjustment, e.g., odd bits constellations >1 (3, 5, 7, 9, 11 bit). For possible LDPC code size, there may be a range of QAM constellations that may be used.

In addition, unequal MCS settings may be applied on spatial streams and carriers. In one example, different QAM constellation settings may be allowed per spatial stream, but within the spatial stream, one QAM constellation may be used. In another example, there may be a QAM constellation setting per spatial stream and frequency carrier group. Different group sizes may be selected (e.g., 1, 2, up to K (the number of carriers)).

To configure unequal modulation per spatial stream within a link, it may not be efficient to select the modulation and FEC setting on the packet error rate (PER) (which may be a single metric for the link). A per-spatial stream and per-carrier group link quality metric may be used, which may be measured efficiently at the receiver and communicated efficiently to the transmitter to select the MCS settings. SNR margin may be used to perform that task. In one example, sounding feedback may be used to estimate the link quality difference over different spatial streams and frequency at the transmitter side. In another example, the receiving STA may report the SNR margin observed in a data packet per spatial stream or per spatial stream and carrier group.

SNR margin may be the difference between the actual SNR and the SNR used by the receiver to achieve the target link quality (e.g., bit error rate and/or packet error rate). The transmitter may use this information together with other measurements to select the MCS setting.

Unequal modulation and coding scheme (UEQM) may allow for a more fine-grained adjustment of the transmission settings to the link quality. MCS settings may allow for approximately 1 bit/3 dB steps between different MCS settings. Thus, if the link quality is too low to use the higher MCS, the MCS settings may fall back to the next lower MCS. Allowing different modulation and coding settings may facilitate finer adjustments because some spatial streams and/or carriers may use a higher QAM constellation and other spatial streams and/or carriers may use a lower QAM constellation, which allows a mix of MCS.

Unequal modulation may also provide for coding efficiency. The link quality of different spatial streams and different carriers may vary over a wide range. When using a single setting for spatial streams/carriers, this setting may be too high for some carriers and too low for other carriers, which may limit the decoder performance. Having the transmission setting adjusted more accurately for a certain carrier and spatial stream may resolve that issue.

In addition, the stability of the receiver detection and equalization may be enhanced. Using a large constellation size on carriers and spatial streams, including those with lower SNR, may make detection on those carriers and/or spatial streams inefficient. While the constellation points of a smaller QAM constellation (with larger distance between constellation points) may be distinguished, this may not be possible with the large QAM constellations. With a large QAM constellation at low SNR, the receiver error may not be determined accurately and receiver adjustments, based on the receiver error, may not be usable. Unequal MCS, in which the QAM constellation size may fit the SNR, may allow for the receiver error to be used to measure performance and adapt the receiver.

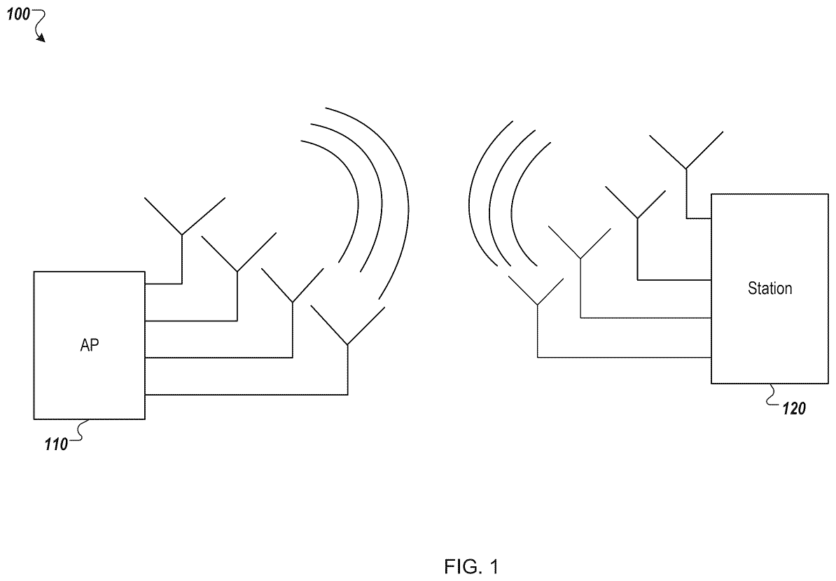

As illustrated in FIG. 1, a network diagram 100 shows an AP 110 that may communicate with a STA 120. The AP 110 may have 4 antennas. The STA 120 may have 4 antennas. The AP 110 may communicate with the STA 120 using beamforming or MIMO precoding. The AP 110 may communicate more than one spatial stream to the STA 120.

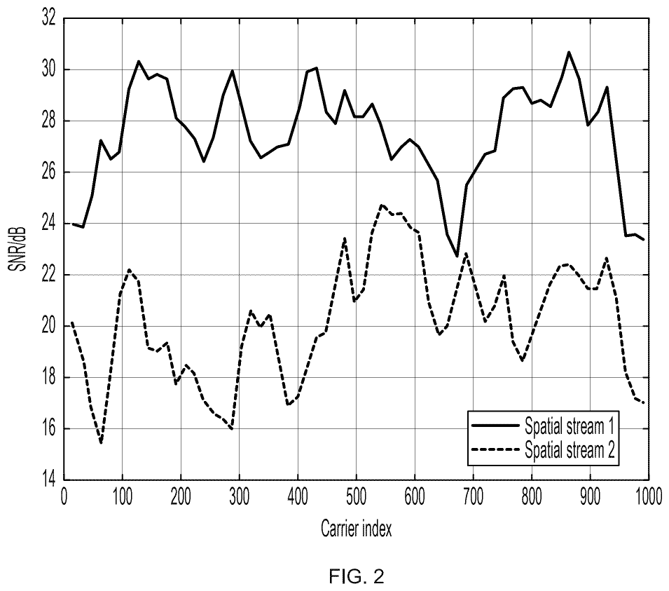

In WLAN links using more than one spatial stream, the different spatial streams may show a different signal-to-noise ratio SNR when beamforming is used. The first spatial stream may have a higher SNR. In addition, SNR may vary over frequency. As illustrated in FIG. 2, the SNR varies as a function of carrier index for spatial stream 1 and spatial stream 2. Spatial stream 2 has a lower SNR when compared to spatial stream 1.

When using the same constellation size and LDPC code rate for spatial streams and carriers, the selected constellation size may be high, causing increased error, or low, reducing the throughput. When using a different constellation size per spatial stream, the modulation and coding scheme may be adapted more precisely to the channel conditions. This may result in increased rate and reduced bit error ratio.

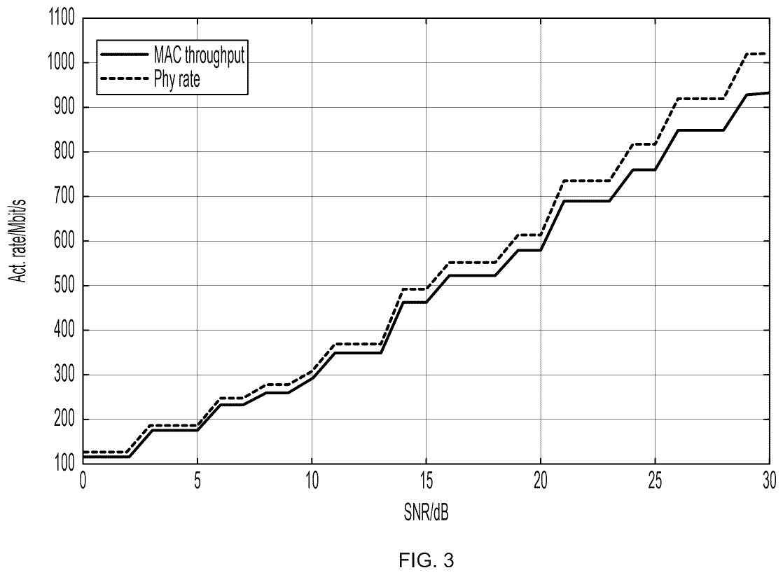

FIG. 3 illustrates the rate in Mbits/s vs. SNR curve in dB of a WLAN transmission. The physical rate and the MAC throughput show coarse rate steps which may be caused by the discrete MCS changes. Unequal constellation size per spatial stream (UEQM) may result in finer rate steps and thus, a gain of data rate.

While the MCS setting used in 802.11 Wi-Fi may be a combination of LDPC code rate and constellation size, unequal modulation may use LDPC code rate and constellation size, separately.

The bits of an LDPC codeword may span over multiple carriers and spatial streams, which may maintain the LDPC interleaving gain. Thus, one LDPC setting may be used for the orthogonal frequency division multiplexing (OFDM) symbol, while the constellation size may be varied for different spatial streams and/or different carriers.

In one example, an AP may identify, at the AP, the forward error correction (FEC) code rate for a plurality of carriers based on the one or more unequal modulation settings; and compute, at the AP, the one or more constellation sizes for the plurality of carriers for transmission to a STA based on the one or more unequal modulation settings.

### Settings:

Table 1 provides code rates and constellation sizes. For most LDPC code rates (except 2/3), multiple constellation sizes may be available. Therefore, unequal modulation may be implemented using these code rate and constellation size pairs.

TABLE 1
MCS

| MCS | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| K/N | 1/2 | 1/2 | 3/4 | 1/2 | 3/4 | 2/3 | 3/4 | 5/6 | 3/4 | 5/6 | 3/4 | 5/6 | 3/4 | 5/6 |
| b | 1 | 2 | 2 | 4 | 4 | 6 | 6 | 6 | 8 | 8 | 10 | 10 | 12 | 12 |
| r_{eff} | 0.5 | 1 | 1.5 | 2 | 3 | 4 | 4.5 | 5 | 6 | 6.67 | 7.5 | 8.33 | 9 | 10 |

As shown in Table 2, support may be provided for additional constellations with LDPC code rate 2/3. For example, support may be provided for constellation sizes 1, 2, 4, 8, 10, and/or 12 for code rate 2/3.

TABLE 2
Constellation sizes per LDPC code rate

| | Constellation size b/bit | | | | | | |
|---|---|---|---|---|---|---|---|
| LDPC K/N | 1 | 2 | 4 | 6 | 8 | 10 | 12 |
| 1/2 | 1 | 2 | 4 | 6 | 8 | 10 | 12 |
| 2/3 | 1 | 2 | 4 | 6 | 8 | 10 | 12 |
| 3/4 | 1 | 2 | 4 | 6 | 8 | 10 | 12 |
| 5/6 | 1 | 2 | 4 | 6 | 8 | 10 | 12 |

With that, the rate 1/2 and 2/3 LDPC codes may be usable until a certain maximum constellation size (4 and 6 bit, respectively). And the 3/4 and 5/6 code rates may be usable from a min. constellation size (2 and 6 bit, respectively). Table 3 shows the additional MCSs (marked with ‘-’).

TABLE 3
MCS, K/N, b, and reff

| mcs | 0 | — | 1 | — | 2 | 3 | — | 4 | 5 | 6 | 7 | — | 8 | 9 | — | 10 | 11 | — | 12 | 13 |
|---|---|---|---|---|---|---|---|---|---|---|---|---|---|---|---|---|---|---|---|---|
| K/N | 1/2 | 2/3 | 1/2 | 2/3 | 3/4 | 1/2 | 2/3 | 3/4 | 2/3 | 3/4 | 5/6 | 2/3 | 3/4 | 5/6 | 2/3 | 3/4 | 5/6 | 2/3 | 3/4 | 5/6 |
| b | 1 | 1 | 2 | 2 | 2 | 4 | 4 | 4 | 6 | 6 | 6 | 8 | 8 | 8 | 10 | 10 | 10 | 12 | 12 | 12 |
| r_{eff} | 0.5 | 0.67 | 1 | 1.33 | 1.5 | 2 | 2.67 | 3 | 4 | 4.5 | 5 | 5.33 | 6 | 6.67 | 6.67 | 7.5 | 8.33 | 8 | 9 | 10 |

When using carrier-dependent constellation sizes, a puncturing mode (b=0) may be supported for the LDPC code rate. One option may be to adjust the constellation size per spatial stream. This may be referred to as unequal modulation. But for finer rate control and to benefit in single spatial stream transmission, frequency-dependent control may be added. This may be done in resource blocks, e.g., 2, 5, 10 or 20 MHz or per carrier.

Wireless LANs may support even bit constellations (2, 4, 6, 8, 10, 12 bit) and the 1-bit (BPSK) constellation as the odd bit constellation. Accordingly, the SNR difference between spatial streams may be around 6 dB to benefit from unequal modulation. In case of a lower SNR difference between the spatial streams, e.g., around 3 dB, odd bit constellations beyond BPSK may be used, e.g., 3, 5, 7, 9 and 11 bit.

In one example, the odd bit constellation with b bits may be generated by pairs of carriers, where one carrier has a square (even bit) constellation with b+1 and a neighboring carrier may use a square constellation size of b−1 bits. The per-carrier transmit power may be different, e.g., higher power for the b+1 bits constellation and lower power for the b−1 bits constellation.

In another example, a rectangular QAM constellation may be used for the b bits constellation, e.g., └b/2┘ bits on the real dimension and ┌b/2┐ in the imaginary dimension or vice versa. A different orientation may be used for different carriers.

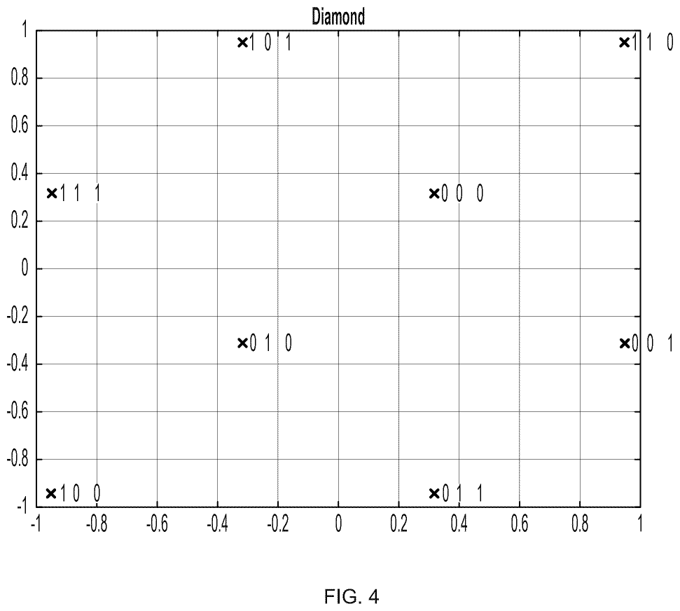

In another example, a diamond-shaped odd bits constellation may be used. As illustrated in FIG. 4 for the example of 3 bits, the larger constellations may be generated by replacing one constellation point of the 3 bit constellation by 4 equidistant constellation points. Like the 1 bit BPSK constellation of wireless LAN, the constellation may be rotated by −45° to have the inner constellation points on the real axis.

In one example, an AP may comprise a processing device. The processing device may determine, at the AP, one or more unequal modulation settings; identify, at the AP, a forward error correction (FEC) code rate for a plurality of spatial streams based on the one or more unequal modulation settings; and compute, at the AP, one or more constellation sizes for the plurality of spatial streams for transmission to a STA based on the one or more unequal modulation settings. The AP may comprise a transceiver operable to transmit a transmission using the FEC code rate and the one or more constellation sizes to the STA.

The LDPC code rate may be 2/3 with a constellation size of one or more of 1, 2, 4, 8, 10, 12. That is, an LDPC code rate of 2/3 may be used with one or more of BPSK, 4-QAM, 16-QAM, 256-QAM, 1024-QAM, and/or 4096-QAM. In addition or alternatively, the one or more constellation sizes may include one or more odd constellations.

A STA may demodulate, at the STA, the one or more spatial streams including a plurality of constellation sizes. That is, different spatial streams may be associated with different constellation sizes.

### Link Adaptation

In addition to introducing unequal modulation in the encoder/decoder the correct constellation size per stream and code rate may be selected.

### Trial-and-Error-Based

The link settings may be derived using the Minstrel algorithm. The Minstrel algorithm is a trial-and-error method in which a set of relevant link settings may be tested, the bit error rate may be observed, and the setting with the highest throughput may be selected as the setting. The number of basic settings may increase from 14 to 17 (adding additional constellations for the rate 2/3 LDPC) or to 28 (possible code rate/constellation size settings for code rates 1/2, 2/3, 3/4, 5/6, and constellation sizes 1, 2, 4, 6, 8, 10, or 12 bits).

When using unequal modulation, the number of possible settings may increase exponentially with the number of spatial streams, slowing down the link adaptation accordingly. For L spatial streams, the search space may be: 3^{L}+4^{L}+6^{L}++4^{L}, with reduced settings and 4·7^{L} for the full search space. For L=2, there may be 77 and 196 options, respectively (compared to 14). For L=4 spatial streams, there may be 1889 and 9604 options (compared to 14). Knowledge about the SNR difference between the spatial streams may be used to guide the decision about which link settings to use.

### Sounding Feedback-Based Adaptation (Open-Loop)

In one example, the AP may determine, at the AP, the one or more unequal modulation settings using an SNR measurement received from a sounding packet from the STA.

The sounding feedback report may contain information about the expected SNR of the beamformed packet, derived from the singular value decomposition at the receiver. The SNR may be reported per spatial stream or per spatial stream and carrier group (group sizes are 4 or 16 carriers).

Based on the SNR from sounding feedback, the SNR margin and the expected bit error rate (BER) of different modulation settings may be estimated to select the best throughput setting. SNR margin γ may be defined as the difference between the actual SNR and the required SNR, e.g.,

$$γ = SNR - S N {R}_{req} ( \frac{K}{N} , b ) .$$

Required SNR Method 1 (Gaussian capacity):

The required SNR may be determined in different ways. One method is the SNR gap to capacity Γ. It may be given by

$$S N {R}_{req} = ( {2}^{\frac{K}{N} b} - 1 ) Γ$$

where Γ is a receiver parameter. This equation may be based on channel capacity with Gaussian modulation (e.g., capacity

$$C = {log}_{2} ( 1 + \frac{S N R}{Γ} ) ) .$$

Thus, there may be the SNR gap of Γ≈1.5 dB from the difference between QAM modulation and Gaussian modulation.

### Required SNR Method 2 (QAM Capacity):

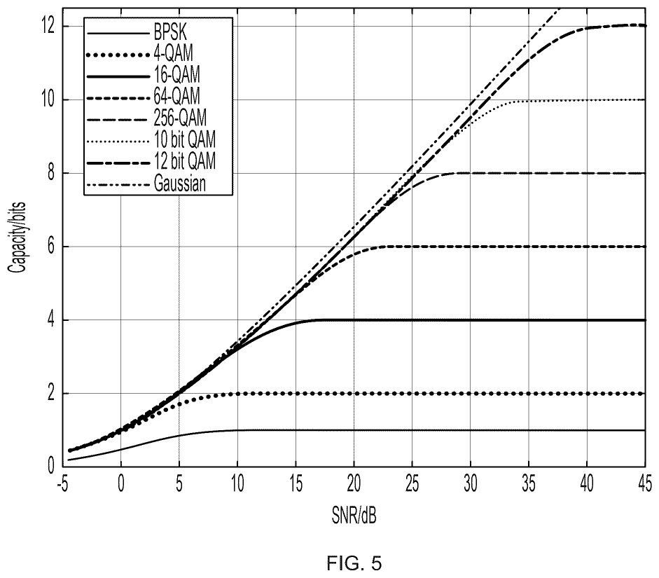

With knowledge of the actual QAM modulation size, the capacity of the actual QAM constellation may be used. FIG. 5 illustrates the dependency between capacity (in bits) and SNR (in dB) for WLAN QAM constellations. For BPSK, the capacity may plateau at about 1 bit when the SNR is about 5 dB. For 4-QAM, the capacity may plateau at about 2 bits when the SNR is about 7 dB. For 16-QAM, the capacity may plateau at about 4 bits when the SNR is about 15 dB. For 64-QAM, the capacity may plateau at about 6 bits when the SNR is about 22 dB. For 256-QAM, the capacity may plateau at about 8 bits when the SNR is about 27 dB. For 10-bit QAM, the capacity may plateau at about 10 bits when the SNR is about 33 dB. For 12-bit QAM, the capacity may plateau at about 12 bits when the SNR is about 40 dB. An equation may provide the SNR_{req} as follows:

$$S N {R}_{req} = S N R : ( C ( b ) = b \frac{K}{N} ) Γ$$

The SNR gap Γ may be used to account for the FEC characteristics and to achieve the target packet error rate.

### Required SNR Method 3 (FEC Model):

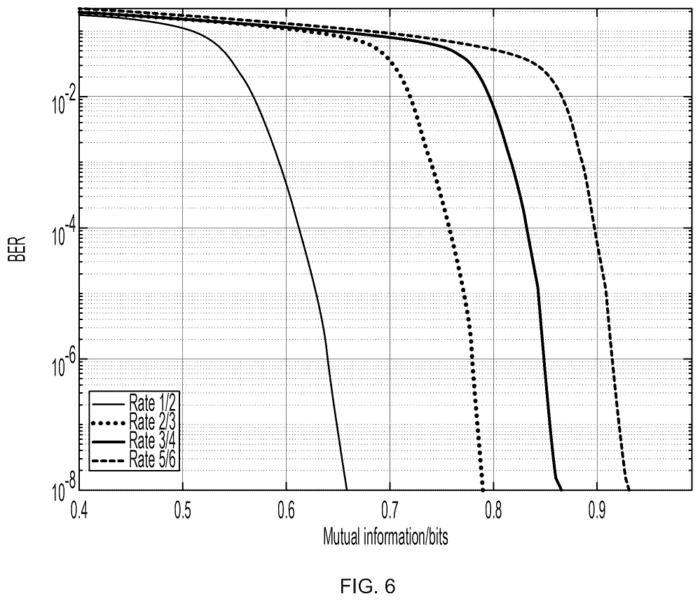

To further refine the required SNR definitions and take the FEC behavior into account, the dependency between mutual information per transmitted bit (or generalized mutual information GMI) and the coded bit error rate, as shown in FIG. 6, may be used. With proper interleaving, this relation between mutual information and coded bit error rate may not be dependent on the constellation size or the individual SNRs.

For example, for a code rate of 1/2, mutual information of about 0.65 may correspond with a BER of about 10⁻⁸. For a code rate of 2/3, mutual information of about 0.79 may correspond with a BER of about 10⁻⁸. For a code rate of 3/4, mutual information of about 0.87 may correspond with a BER of about 10⁻⁸. For a code rate of 5/6, mutual information of about 0.93 may correspond with a BER of about 10⁻⁸.

For a given code rate and target BER, the GMI may be derived from FIG. 6 in the first operation. With the GMI value, the required SNR may be taken from the capacity-SNR dependency of FIG. 5 according to:

$$S N {R}_{req} = S N R : ( C ( b ) = G M I ( \frac{K}{N} , B E {R}_{target} ) ) Γ .$$

The required SNR for the FEC code rate and constellation size may be derived in various ways to provide Table 4. In case that certain combinations of code rate and constellation size are not allowed, those may be excluded from the table.

TABLE 4
Required SNR for Various Constellation
Sizes b and FEC code rates K/N

| SNR_{req}/dB | K/N = 1/2 | K/N = 2/3 | K/N = 3/4 | K/N = 5/6 |
|---|---|---|---|---|
| B = 1 | −0.94 | 0.87 | 1.83 | 3.06 |
| B = 2 | 2.06 | 3.87 | 4.84 | 6.06 |
| B = 4 | 7.60 | 9.89 | 11.05 | 12.45 |
| B = 6 | 12.20 | 15.09 | 16.48 | 18.10 |
| B = 8 | 16.47 | 20.05 | 21.73 | 23.59 |
| B = 10 | 20.60 | 24.92 | 26.92 | 29.06 |
| B = 12 | 24.64 | 29.73 | 32.08 | 34.54 |

By using link adaptation the setting with the highest effective throughput may be determined. In one example, this may be done to facilitate positive SNR margin on the spatial streams.

To derive the SNR margin per spatial stream/from SNR values per carrier k, the SNR may be averaged. Hereby, averaging over mutual information may be used

$${C}_{a v g , l} = {\sum }_{k = 1}^{K} {log}_{2} ( 1 + \frac{S N {R}_{l}^{( k )}}{Γ} ) .$$

The SNR margin may be

$${γ}_{l} = \frac{( {2}^{{C}_{avg , l}} - 1 )}{S N {R}_{req , l}} .$$

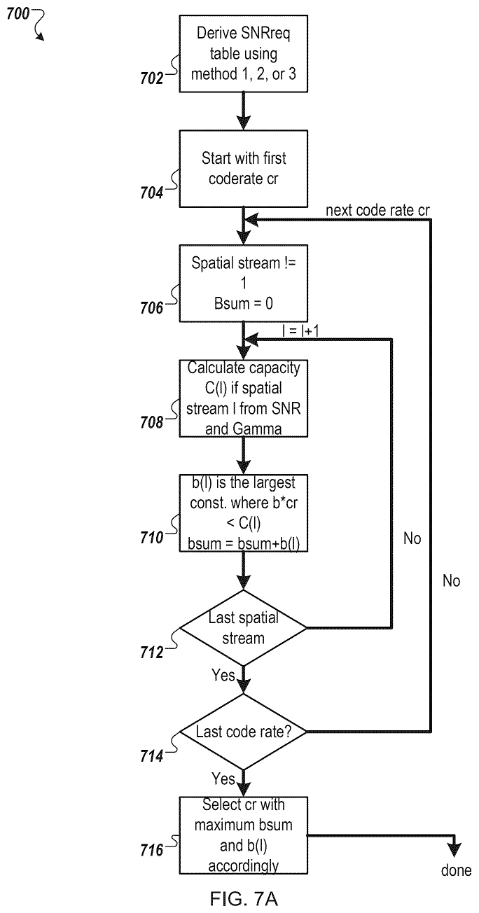

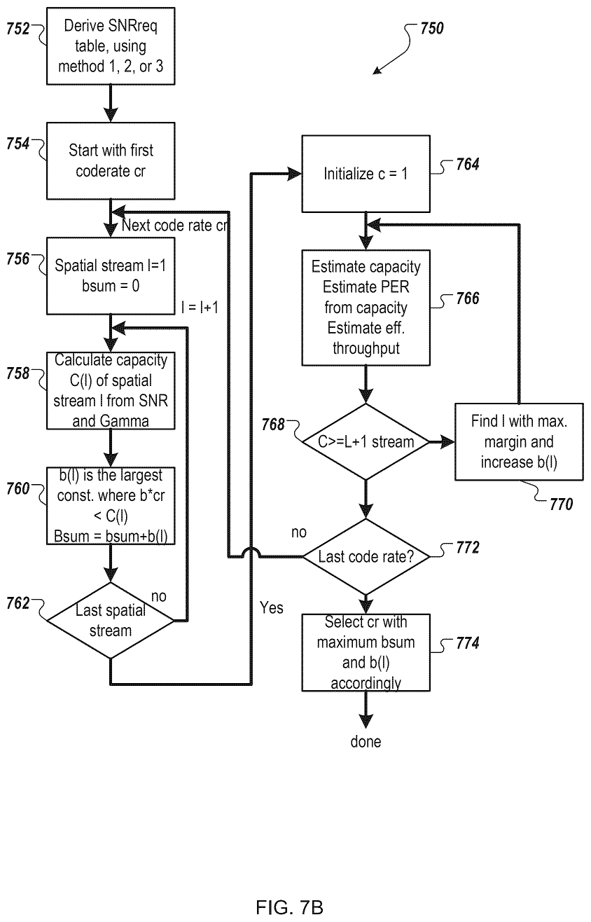

FIG. 7A summarizes a method 700 to search for the appropriate code rate and constellation size. The AP may derive SNR_{req} table (e.g., Table 4) using one or more of method 1 (e.g., Gaussian capacity), method 2 (e.g., QAM capacity), or method 3 (e.g., FEC model), as shown in operation 702. The AP may start with a first coderate, cr, as shown in operation 704. In operation 706, the AP may, when a spatial stream is not equal to 1, set the Bsum to 0. In operation 708, the AP may calculate the capacity C(1) for a spatial stream 1 using SNR and gamma. In operation 710, the AP may determine b(1) in which b(1) is the largest constant in which b*cr is less than C(1). The AP may set bsum to be equal to bsum+b(1).

In operation 712, the AP may determine if the last spatial stream has been reached. When the last spatial stream has not been reached, then a counter may be set to be equal to ‘1’=‘1’+1 and operations 708, and 710 may be repeated. When a last spatial stream has been reached, then the AP may determine that a last code rate has been reached, as shown in operation 714. When a last code rate has not been reached, then the next code rate may be set and operations 706, 708, 710, and 712 may be repeated. When a last code rate has been reached, then the AP may select a cr with a maximum bsum and b(1) accordingly, as shown in operation 716.

In some cases, the method 700 of FIG. 7A may be conservative, as it may neglect the averaging effect of the margin of individual spatial streams, e.g., if 1 spatial stream has positive margin and another spatial stream has negative margin, the FEC may compensate the negative margin of one spatial stream to a limited extent. To take that into account, the packet error rate may be estimated, based on the sum capacity of spatial streams, e.g., by using FIG. 6. When the packet error ratio for the initial setting (with streams having positive margin) is below the target error ratio, the constellation size of the spatial stream with highest margin may be increased and the packet error rate may be re-calculated until the packet error ratio is above the target value.

FIG. 7B summarizes this method 750. Operations 752, 754, 756, 758, 760, and 762 may correspond to operations 702, 704, 706, 708, 710, and 712 from FIG. 7A, respectively, and may have the same or similar functionality. When a last spatial stream has been reached, the AP may initialize c=1, as shown in operation 764. Following this operation, the AP may estimate capacity, PER from capacity, and estimate effective throughput, as shown in operation 766.

The AP may, when C is not greater than or equal to L+1 streams, as shown in operation 768, find I with maximum margin and increase b(1), as shown in operation 770. After operation 770, operation 766 and 768 may be repeated. The AP may, when C is greater than or equal to L+1 streams, as shown in operation 768, proceed to operation 772. In 772, the AP may determine when a last code rate has been reached. When a last code rate has not been reached, operations 756, 758, 760, 762, 764, 766, and 768 may be repeated. When a last code rate has been reached, the AP may select the cr with the maximum bsum and b(1) accordingly, as shown in operation 774.

After testing code rates, the setting with the highest overall throughput may be selected.

### Packet Error Rate Receiver Feedback

In one example, the AP may determine, at the AP, the one or more unequal modulation settings using a signal-to-noise ratio (SNR) margin feedback from a data packet received from the STA. The AP may determine, at the AP, the one or more unequal modulation settings using signal-to-noise ratio (SNR) margin feedback and packet error statistics.

The link adaptation procedures of FIGS. 7A and 7B may not consider receiver feedback, but a model of the receiver may be assumed to generate required SNR values for the constellation/code rate setting.

The methods used to derive the required SNR values may use the SNR gap I′ as a parameter to reflect the receiver characteristics. Like the existing trial-and-error based link adaptation methods, which use the packet error rate (derived from acknowledgements) as feedback, the SNR gap I may be controlled by the observed packet error rate.

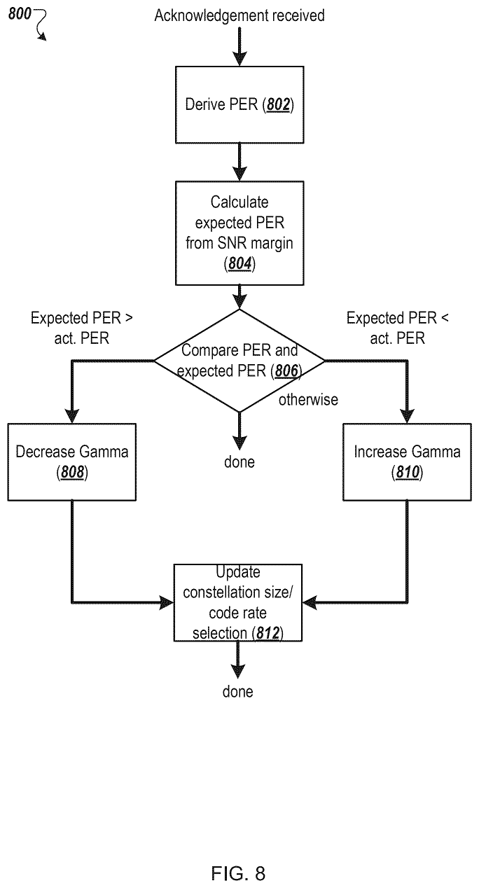

The method 800 may be summarized in FIG. 8. An AP may receive an acknowledgement. The AP may derive the PER, as shown in operation 802. The AP may calculate the expected PER using the SNR margin, as shown in operation 804. The AP may compare the PER and expected PER, as shown in operation 806. When the PER and expected PER are equal, then the method 800 may be done. When the expected PER is greater than the actual PER, the gamma may be decreased, as shown in operation 808. When the expected PER is less than the actual PER, the gamma may be increased, as shown in operation 810. After decreasing or increasing the gamma, the AP may update the constellation size and code rate selection, as shown in operation 812.

A certain minimum PER may be used to tune the SNR margin, because with too few errors, the measurement may not be accurate. Thus, a constant packet loss may be used for the measurement. There may be no feedback per spatial stream, but per station. When the expected SNR difference between the spatial streams is not correct, the SNR gap may be unnecessarily high. To resolve the issues, SNR margin per spatial stream (and per carrier group or per carrier for carrier-dependent bit allocation) may be used.

### SNR Margin Feedback

A STA may include a processing device that may: compute, at the STA, one or more SNR margins for one or more spatial streams; and send, from the STA to an AP, the SNR margins for the one or more spatial streams.

In one example, the receiver may provide SNR margin feedback γₗ per spatial stream/in addition to the acknowledgements, e.g., as part of the acknowledgement packet. To support unequal modulation per carrier group and spatial stream, frequency-dependent SNR margin γₗ^{(k)} may be reported.

The SNR margin feedback may be derived at the receiver from the data packet. The SNR margin may be defined as the SNR difference between the required SNR and the actual SNR. When the actual SNR is a quantity that may not be present in the receiver (e.g., for nonlinear detection schemes), methods to derive the SNR margin at different receiver types may be used.

The SNR margin may be the maximum noise increase that may be acceptable to satisfy the target link quality (e.g., target PER or BER). There are various ways to derive the SNR margin from receive signal.

### Method 1 (SNR-Based):

In one example, the STA may compute the one or more SNR margins using receiver error.

In linear receivers, the SNR may be derived from the slicer errors at the receiver output. Assuming the transmit signal uₗ^{(k)}, a receive signal at the equalizer output of ûₗ^{(k)} and a hard decision output ūₗ^{(k)}, all normalized to unit power. Then the receiver error may be eₗ^{(k)}=ûₗ^{(k)}−uₗ^{(k)}, which may be approximated at the receiver by eₗ^{(k)}=ûₗ^{(k)}−ūₗ^{(k)}. This approximation may cause an over-estimation of the SNR (error under-estimation), but within the operating range of the receiver, the error may be small. The SNR may be given by

$$S N {R}_{l}^{( k )} = \frac{1}{\frac{1}{T} {\sum }_{t = 1 , … , T} {\vert {e}_{l}^{( k ) , t} \vert}^{2}} .$$

To derive a single per-stream margin from the per-carrier SNR values, the equations

$${C}_{a v g , l} = {\sum }_{k = 1}^{K} {log}_{2} ( 1 + \frac{S N {R}_{l}^{( k )}}{{Γ}_{r x}} ) and {γ}_{l} = \frac{( {2}^{{C}_{avg , {l}_{- 1 )}}}}{S N {R}_{req , l}}$$

may be used. Hereby, Γᵣₓ may be a control parameter of the receiver to maintain a certain target BER or PER, and account for the receiver and FEC characteristics. With higher Γᵣₓ, a lower BER and PER may be achieved. Hereby, Γᵣₓ may be different from the SNR gap Γ, because the transmitter and the receiver may use different required SNR values.

### Method 2 (BER-Based):

In one example, the STA may compute the one or more SNR margins using raw bits errors prior to forward error correction (FEC) decoding.

An alternative may be the measurement of the raw bit error rate. There may be receiver architectures where the slicer error eₗ^{(k)} may not be available and thus, SNR measurement may not be applicable. The raw bit errors prior to FEC decoding may be counted per spatial stream BER_{raw,l}, or per spatial stream and carrier group BER_{raw,l}^{(k)}.

To count the bit errors, some successfully decoded FEC codewords may be re-encoded and compared to the raw bits. The relation between raw BER and coded BER may depend on the FEC settings and the constellation size.

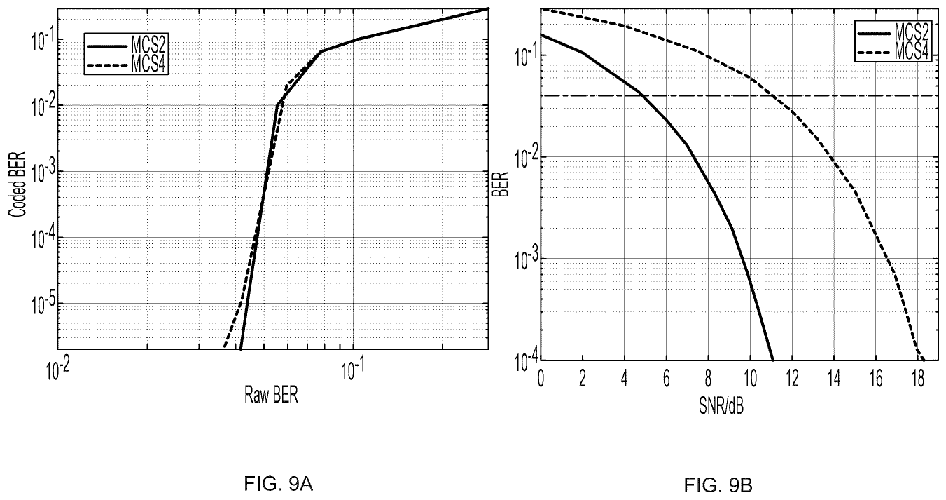

An example may be given by FIG. 9A for LDPC code rate 3/4, indicating an input BER around 4e-2 for this LDPC code rate. To report SNR margin in dB, the raw BER values may be mapped to SNR. For the additive white Gaussian noise (AWGN) channel, there may be a strict dependency between BER and SNR, as shown in FIG. 9B for the example of 4-QAM and 16-QAM. The difference between the actual (measured) raw BER and the target raw BER may be mapped to two SNR values, using the AWGN BER vs. SNR curves.

$$S N {R}_{ref , meas} = S N {R}_{A W G N} : B E {R}_{raw , AWGN} = B E {R}_{raw , m e a s}$$

$$SN {R}_{req} = S N {R}_{A W G N} : B E {R}_{raw , AWGN} = B E {R}_{raw , r e q}$$

The difference between these SNR values may be the SNR margin:

$$γ = S N {R}_{ref , meas} - S N {R}_{req}$$

### Method 3 (LLR-Based):

In one example, the STA may compute the one or more SNR margins using log likelihood ratio (LLR) statistics. The STA may compute, at the STA, the one or more SNR margins for one or more carriers.

Receivers may use soft decision decoding. Thus, the raw BER may not be an exact method to characterize the FEC input. Soft decision decoding may use LLR as input. The statistics of the LLR values may be used to characterize the mutual information per spatial stream (and carrier) and thus, to derive the SNR margin.

Assuming a transmitted bit sequence uᵢ and the llr value llr∈{−llrₘₐₓ, . . . , llrₘₐₓ}, corresponding to the transmitted bit, the mutual information may be given by

$$I ( {u}_{i} , llr ) = {\sum }_{{u}_{i} ∈ \{ 0 , 1 \}} {\sum }_{llr ∈ \{ - l l {r}_{max} , … , {llr}_{max} \}} {p}_{{u}_{i} , llr} ( {u}_{i} , llr ) {log}_{2} ( \frac{{p}_{{u}_{i} , llr} ( {u}_{i} , llr )}{{p}_{{u}_{i}} ( {u}_{i} ) {p}_{l l r} ( l l r )} ) .$$

Here, pᵤ_{ᵢ}(uᵢ) is the probability to transmit bit uᵢ (usually uᵢ=0.5), pₗₗᵣ(llr) is the probability to receive LLR value llr and pᵤ_{ᵢ}_{,llr}(uᵢ, llr) is the probability to receive LLR value llr when transmit bit uᵢ is transmitted. The transmitted bits may be recovered, e.g., from the FEC decoder output of a successfully decoded codeword.

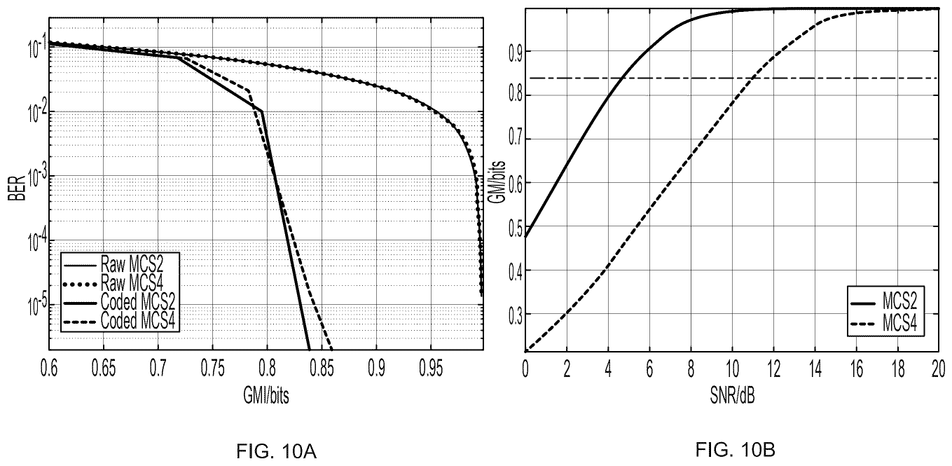

An example for the dependency between input and coded BER and mutual information may be given in FIG. 10A for MCS2 and MCS4 (rate 3/4 code). A GMI around 0.84 may be expected for a BER around 1e-5. In FIG. 10B, the dependency between SNR and GMI for two constellation sizes (4-QAM/MCS2 and 16-QAM/MCS4) is shown.

Like the SNR-based SNR margin, SNR margin may be derived from the GMI according to

$${γ}_{l} = \frac{( {2}^{{C}_{avg , l}} - 1 )}{S N {R}_{req , l}}$$

Hereby, C_{avg,l}=GMI bₗ. It may be noted that the SNR margin values computed from GMI saturate, because the GMI curve approaches 1 for high SNR.

### Communication Protocol:

In one example, an AP may send, at the AP for transmission to the STA, a modulation order difference in a data packet preamble. A STA may receive, at the STA from the AP, a data packet preamble comprising a modulation difference per spatial stream.

To use unequal modulation, different modulation per spatial stream may be communicated from the transmitter to the receiver. In current WLAN, the MCS is part of the packet preamble. The MCS index from 0 to 13 may describe a certain combination of constellation size and LDPC code rate.

For backward compatible operation, the MCS setting may be communicated. In addition, the modulation index difference Ab may be communicated per spatial stream (with respect to the MCS). Thus, the MCS setting may define the FEC code rate K/N and the modulation setting for Ab-0. For the spatial stream (including the first), the Ab value may determine the relative change of modulation order. Thus, the actual constellation size for spatial stream/may be b(MCS)+Ab(l).

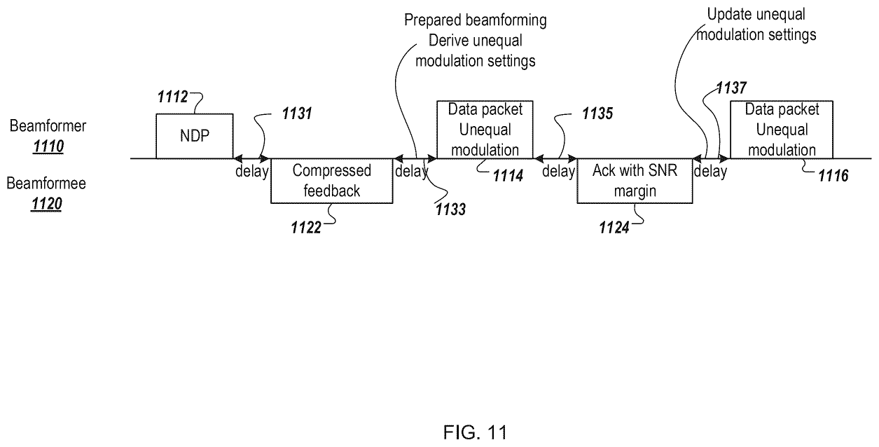

To select the correct unequal modulation settings, SNR feedback from the receiver may be used, e.g., through a sounding packet. The sequence of packets for a beamformed transmission with unequal modulation may be shown in FIG. 11. The diagram 1100 may include a sequence of packets between a beamformer 1110 and a beamformee 1120. The beamformer 1110 may transmit a null data packet (NDP), as shown in block 1112. Following a delay 1131, the beamformee 1120 may transmit compressed feedback, as shown in block 1122. During a delay 1133, the beamformer 1110 may prepare beamforming and derive unequal modulation settings. The beamformer 1110 may transmit a data packet using unequal modulation, as shown in block 1114. Following a delay 1135, the beamformee 1120 may transmit an acknowledgement with an SNR margin, as shown in block 1124. During a delay 1137, the beamformer 1110 may update unequal modulation settings. Following the delay 1137, the beamformer may transmit the data packet 1116 with unequal modulation.

That is, from the SNR of the null data packet (NDP) transmission, the initial unequal modulation setting may be derived and the data packet may be transmitted with the corresponding settings. Based on the acknowledgement of the data packet, the settings may be refined, using the packet error rate derived from the acknowledgement and the SNR margin per spatial stream information. The next data packet may be transmitted with the updated settings.

### EXAMPLES

In one example, a WLAN transmitter may transmit with different constellation sizes on different spatial streams to the same STA, while the same FEC setting may be used for spatial streams and the FEC code bytes may be spread over spatial streams. In one example, SNR measurement from the receiver (STA) may be used, e.g. from a dedicated sounding packet to derive the unequal modulation settings. In another example, SNR margin feedback from the data packet may be used to refine the unequal modulation settings. In another example, odd constellations may be used for a finer resolution of modulation settings.

In another example, a WLAN transmitter may use different constellation sizes for different carriers (or groups of carriers), in addition to different constellation size per spatial stream while the same FEC setting may be used for carriers and spatial streams. In one example, SNR measurement from the receiver (STA) may be used, e.g. from a dedicated sounding packet to derive the unequal modulation settings. In another example, SNR margin feedback from the data packet may be used to refine the unequal modulation settings. In another example, odd constellations may be used for a finer resolution of modulation settings.

In another example, a WLAN receiver may derive SNR margin per spatial stream and report it to the transmitter. In one example, the SNR derived from the receiver error per spatial stream may be used to derive the SNR margin. In another example, the raw bit errors (prior to FEC decoding) per spatial stream may be used to derive the SNR margin. In another example, the LLR statistics (probability of bit flip per LLR value) per spatial stream may be used to derive the SNR margin.

In another example, a WLAN receiver may derive SNR margin per spatial stream and per carrier (or group of carriers) and report it to the transmitter. The SNR may be derived from the receiver error per spatial stream and carrier or carrier group and may be used to derive the SNR margin. The raw bit errors (prior to FEC decoding) per spatial stream and carrier or carrier group may be used to derive the SNR margin. The LLR statistics (probability of bit flip per LLR value) per spatial stream and carrier or carrier group may be used to derive the SNR margin.

In another example, a WLAN transmitter may use SNR margin feedback and packet error statistics to derive unequal modulation settings.

In another example, a WLAN transmitter may communicate modulation order difference in the preamble of a data packet.

In another example, a WLAN receiver may receive a WLAN packet preamble that contains the modulation difference per spatial stream. After receiving the preamble with modulation difference information, the spatial streams may be demodulated with the corresponding (different) constellation sizes. The FEC decoding may be done jointly and the FEC codewords may be spread over different spatial streams.

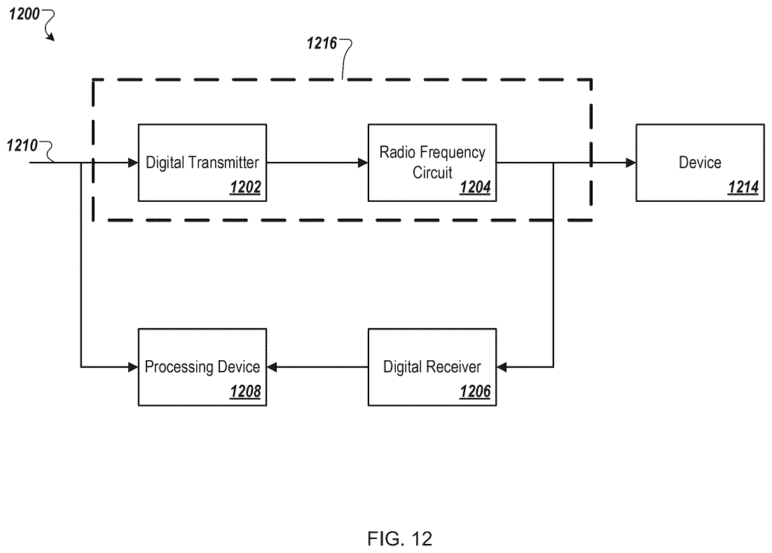

FIG. 12 illustrates a block diagram of an example communication system 1200 configured for unequal modulation, in accordance with at least one example described in the present disclosure. The communication system 1200 may include a digital transmitter 1202, a radio frequency circuit 1204, a device 1214, a digital receiver 1206, and a processing device 1208. The digital transmitter 1202 and the processing device may receive a baseband signal via connection 1210. A transceiver 1216 may include the digital transmitter 1202 and the radio frequency circuit 1204.

In some examples, the communication system 1200 may include a system of devices that may be configured to communicate with one another via a wired or wireline connection. For example, a wired connection in the communication system 1200 may include one or more Ethernet cables, one or more fiber-optic cables, and/or other similar wired communication mediums. Alternatively, or additionally, the communication system 1200 may include a system of devices that may be configured to communicate via one or more wireless connections. For example, the communication system 1200 may include one or more devices configured to transmit and/or receive radio waves, microwaves, ultrasonic waves, optical waves, electromagnetic induction, and/or similar wireless communications. Alternatively, or additionally, the communication system 1200 may include combinations of wireless and/or wired connections. In these and other examples, the communication system 1200 may include one or more devices that may obtain a baseband signal, perform one or more operations to the baseband signal to generate a modified baseband signal, and transmit the modified baseband signal, such as to one or more loads.

In some examples, the communication system 1200 may include one or more communication channels that may communicatively couple systems and/or devices included in the communication system 1200. For example, the transceiver 1216 may be communicatively coupled to the device 1214.

In some examples, the transceiver 1216 may obtain a baseband signal. For example, as described herein, the transceiver 1216 may generate a baseband signal and/or receive a baseband signal from another device. In some examples, the transceiver 1216 may transmit the baseband signal. For example, upon obtaining the baseband signal, the transceiver 1216 may transmit the baseband signal to a separate device, such as the device 1214. Alternatively, or additionally, the transceiver 1216 may modify, condition, and/or transform the baseband signal in advance of transmitting the baseband signal. For example, the transceiver 1216 may include a quadrature up-converter and/or a digital to analog converter (DAC) that may modify the baseband signal. Alternatively, or additionally, the transceiver 1216 may include a direct radio frequency (RF) sampling converter that may modify the baseband signal.

In some examples, the digital transmitter 1202 may obtain a baseband signal via connection 1210. In some examples, the digital transmitter 1202 may up-convert the baseband signal. For example, the digital transmitter 1202 may include a quadrature up-converter to apply to the baseband signal. In some examples, the digital transmitter 1202 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1202.

In some examples, the transceiver 1216 may include one or more subcomponents that may be used in preparing the baseband signal and/or transmitting the baseband signal. For example, the transceiver 1216 may include an RF front end (e.g., in a wireless environment) which may include a power amplifier (PA), a digital transmitter (e.g., 1202), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1204) of the transceiver 1216 may be synchronized with the resource controller via the S-plane device, which may contribute to high-accuracy timing with respect to a reference clock.

In some examples, the transceiver 1216 may obtain the baseband signal for transmission. For example, the transceiver 1216 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 1216 may generate a baseband signal for transmission. In these and other examples, the transceiver 1216 may transmit the baseband signal to another device, such as the device 1214.

In some examples, the transceiver 1216 may be configured to receive a transmission from the device 1214. For example, the transceiver 1216 may transmit a baseband signal to the device 1214.

In some examples, the radio frequency circuit 1204 may transmit the digital signal received from the digital transmitter 1202. In some examples, the radio frequency circuit 1204 may transmit the digital signal to the device 1214 and/or the digital receiver 1206. In some examples, the digital receiver 1218 may receive a digital signal from the RF circuit and/or send a digital signal to the processing device 1208.

In some examples, the processing device 1208 may be a standalone device or system, as illustrated. Alternatively, or additionally, the processing device 1208 may be a component of another device and/or system. For example, in some examples, the processing device 1208 may be included in the transceiver 1216. In instances in which the processing device 1208 is a standalone device or system, the processing device 1208 may communicate with additional devices and/or systems remote from the processing device 1208, such as the transceiver 1216 and/or the device 1214. For example, the processing device 1208 may send and/or receive transmissions from the transceiver 1216 and/or the device 1214. In some examples, the processing device 1208 may be combined with other elements of the communication system 1200.

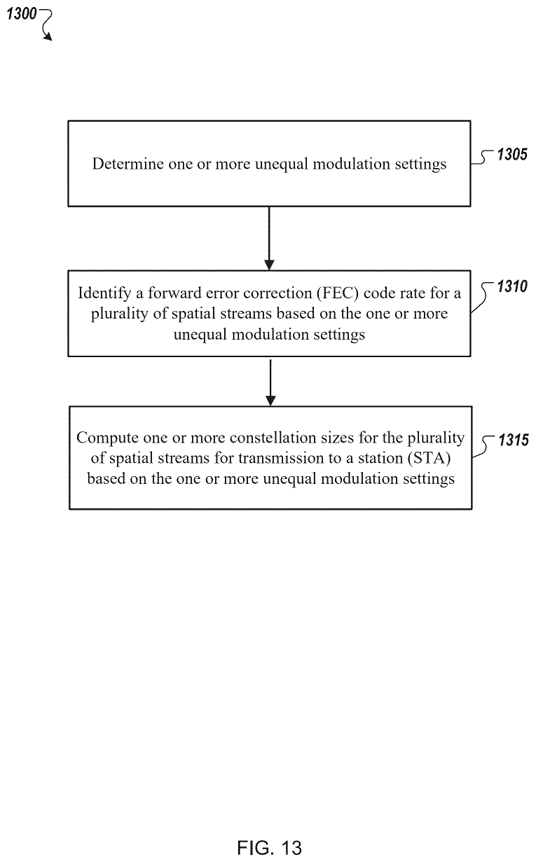

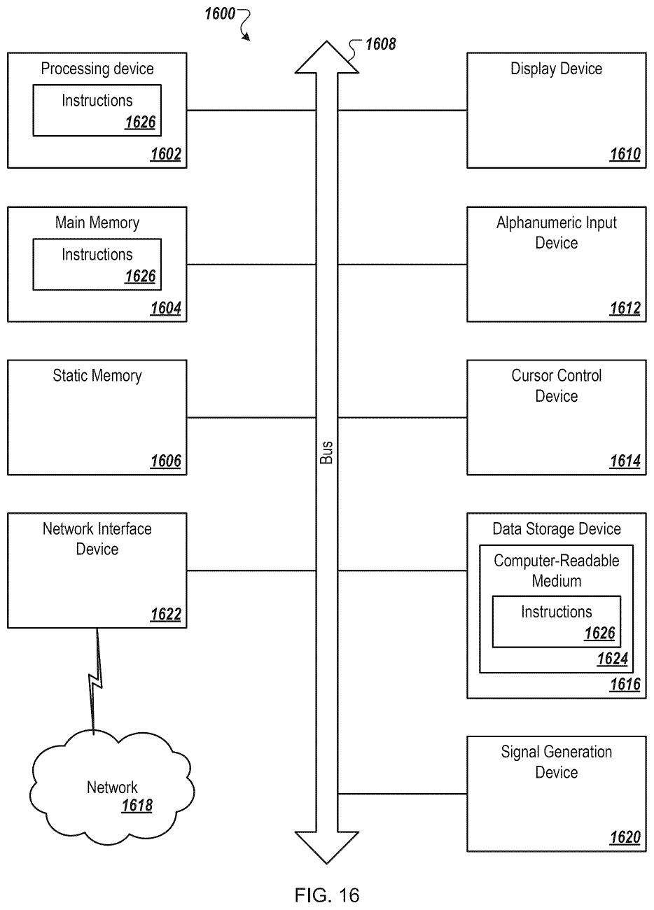

FIG. 13 illustrates a process flow of an example method 1300 of unequal modulation, in accordance with at least one example described in the present disclosure. The method 1300 may be arranged in accordance with at least one example described in the present disclosure. The method 1300 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1300 may begin at block 1305 where the processing logic may determine, at the AP, one or more unequal modulation settings. At block 1310, the processing logic may identify, at the AP, a forward error correction (FEC) code rate for a plurality of spatial streams based on the one or more unequal modulation settings. At block 1315, the processing logic may compute, at the AP, one or more constellation sizes for the plurality of spatial streams for transmission to a STA based on the one or more unequal modulation settings.

Modifications, additions, or omissions may be made to the method 1300 without departing from the scope of the present disclosure. For example, in some examples, the method 1300 may include any number of other components that may not be explicitly illustrated or described.

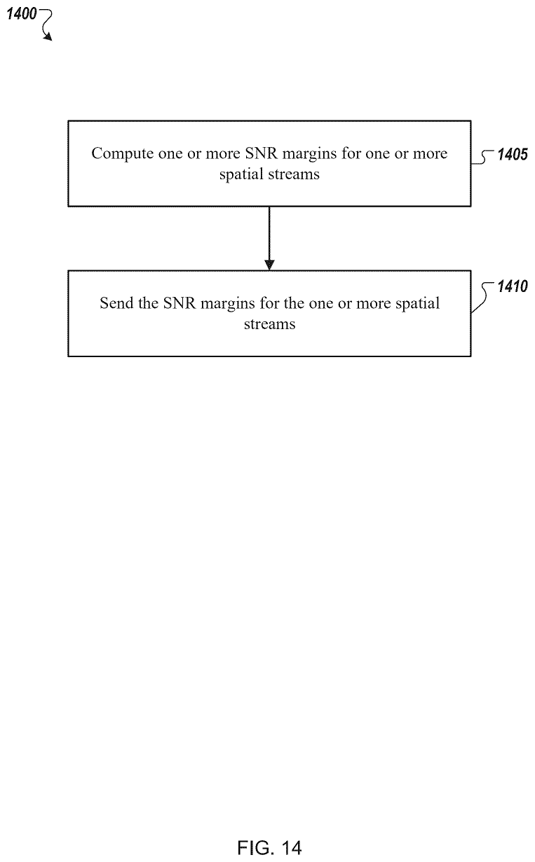

FIG. 14 illustrates a process flow of an example method 1400 of unequal modulation, in accordance with at least one example described in the present disclosure. The method 1400 may be arranged in accordance with at least one example described in the present disclosure. The method 1400 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1400 may begin at block 1405 where the processing logic may compute, at the STA, one or more SNR margins for one or more spatial streams. At block 1410, the processing logic may send, from the STA to an AP, the SNR margins for the one or more spatial streams.

Modifications, additions, or omissions may be made to the method 1400 without departing from the scope of the present disclosure. For example, in some examples, the method 1400 may include any number of other components that may not be explicitly illustrated or described.

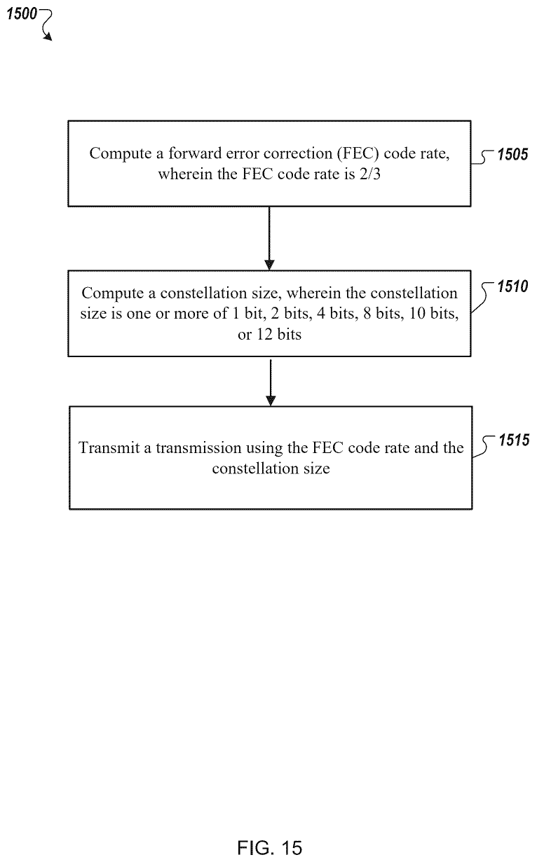

FIG. 15 illustrates a process flow of an example method 1500 of unequal modulation, in accordance with at least one example described in the present disclosure. The method 1500 may be arranged in accordance with at least one example described in the present disclosure. The method 1500 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1500 may begin at block 1505 where the processing logic may compute, at the AP, a forward error correction (FEC) code rate in which the FEC code rate is 2/3. At block 1510, the processing logic may compute, at the AP, a constellation size in which the constellation size is one or more of 1 bit, 2 bits, 4 bits, 8 bits, 10 bits, or 12 bits. At block 1515, the processing logic may transmit, from the AP to a STA, a transmission using the FEC code rate and the constellation size.

The method 1500 may further include sending, at the AP for transmission to the STA, a modulation order difference in a data packet preamble. The method 1500 may further include determining, at the AP, one or more unequal modulation settings.

Modifications, additions, or omissions may be made to the method 1500 without departing from the scope of the present disclosure. For example, in some examples, the method 1500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 16 illustrates a diagrammatic representation of a machine in the example form of a computing device 1600 within which a set of instructions, for causing the machine to perform any one or more of the methods discussed herein, may be executed. The computing device 1600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1600 includes a processing device 1602, a main memory 1604 (e.g., read-only memory (ROM), flash memory, dynamic random access memory (DRAM) such as synchronous DRAM (SDRAM)), a static memory 1606 (e.g., flash memory, static random access memory (SRAM)) and a data storage device 1616, which communicate with each other via a bus 1608.

Processing device 1602 represents one or more general-purpose processing devices such as a microprocessor, central processing unit, or the like. More particularly, the processing device 1602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also include one or more special-purpose processing devices such as an application specific integrated circuit (ASIC), a field programmable gate array (FPGA), a digital signal processor (DSP), network processor, or the like. The processing device 1602 is configured to execute instructions 1626 for performing the operations and steps discussed herein.

The computing device 1600 may further include a network interface device 1622 which may communicate with a network 1618. The computing device 1600 also may include a display device 1610 (e.g., a liquid crystal display (LCD) or a cathode ray tube (CRT)), an alphanumeric input device 1612 (e.g., a keyboard), a cursor control device 1614 (e.g., a mouse) and a signal generation device 1620 (e.g., a speaker). In at least one example, the display device 1610, the alphanumeric input device 1612, and the cursor control device 1614 may be combined into a single component or device (e.g., an LCD touch screen).

The data storage device 1616 may include a computer-readable storage medium 1624 on which is stored one or more sets of instructions 1626 embodying any one or more of the methods or functions described herein. The instructions 1626 may also reside, completely or at least partially, within the main memory 1604 and/or within the processing device 1602 during execution thereof by the computing device 1600, the main memory 1604 and the processing device 1602 also constituting computer-readable media. The instructions may further be transmitted or received over a network 1618 via the network interface device 1622.

While the computer-readable storage medium 1624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to embodiments of the present disclosure.

### Example 1: BER Vs. Channel SNR for Unequal Constellation and Equal Constellation Size Per Spatial Stream on the B LOS Channel

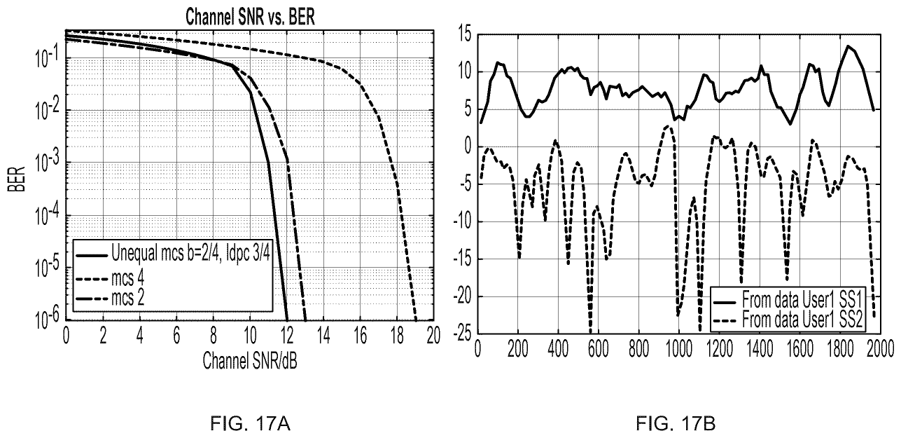

The effectiveness of unequal modulation is shown in FIG. 17 for an example with 2 transmit (TX) antennas, 2 receive (RX) antennas, and 2 spatial streams transmission. BER curves for MCS2 (4-QAM, LDPC rate 3/4), MCS 4 (16-QAM, LDPC rate 3/4) and unequal modulation (16-QAM/4-QAM, LDPC ocde 3/4) is shown in Error! Reference source not found. A. Unequal modulation transmitted at a higher rate 4.5 bit/s/Hz vs. 3 bit/s/Hz for MCS2 and at a lower SNR. The SNR of the spatial stream is shown in Error! Reference source not found. B.

### Example 2: Required SNR for Equal and Unequal Modulation with Different SNR Differences on the I Channel

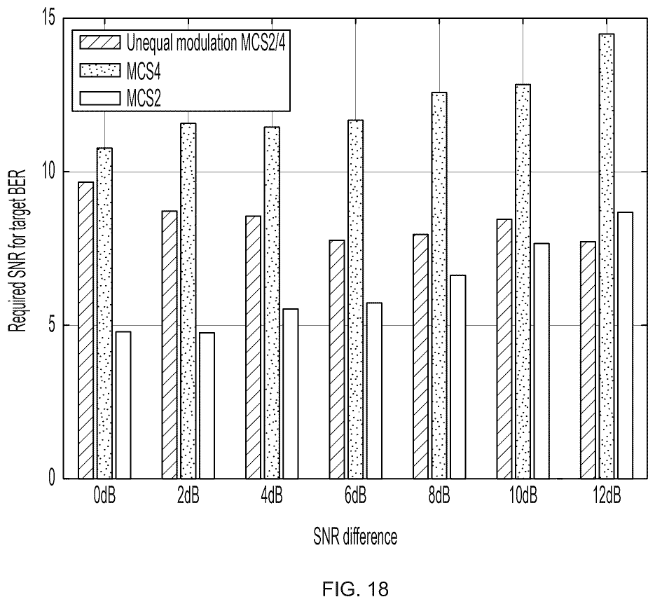

Unequal modulation may be more effective when there is a high SNR difference between the spatial streams, as FIG. 18 shows. FIG. 18 shows the required SNR to achieve a target BER of 1e-5 on an AWGN channel with different SNR differences between the spatial streams.

Without the SNR difference between the spatial streams, the required SNR for unequal modulation with MCS 4/2 was slightly below the required SNR for equal modulation with MCS4, even though the effective rate was lower (4.5 bit/carrier vs. 6 bit/carrier). At 6 dB SNR difference, the performance of equal modulation degraded, while the unequal modulation improved and at 12 dB SNR difference, unequal modulation achieved the target BER at a lower SNR than equal modulation with MCS2, which is in line with the results on a WLAN channel with beamforming in FIG. 17.

### Example 3: Rate Vs. Reach Curve for a Single B LOS Channel for Equal Modulation Vs. Unequal Modulation Rate Vs. Range Curve

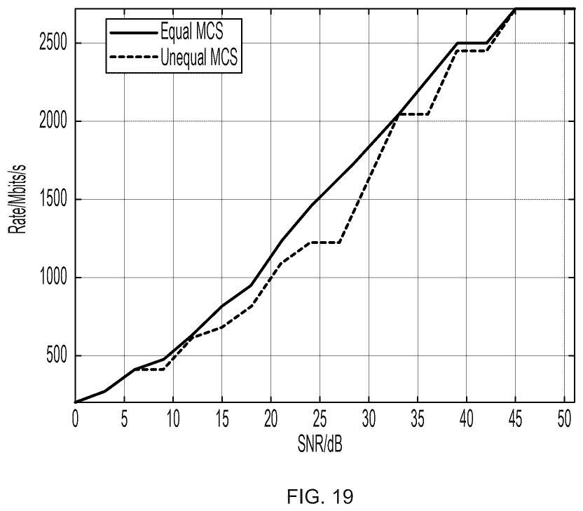

For unequal modulation, besides performance, there may be finer rate steps, and thus a smooth rate vs. reach curve. This is shown in FIG. 19. While the equal modulation rate-vs. range curve has a few rate steps, the unequal modulation curve may be smooth over a wide range of SNR. At low SNR (1 spatial stream) and high SNR (max. constellation size), steps may be visible.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
determine, at the AP, one or more unequal modulation settings;
identify, at the AP, a forward error correction (FEC) code rate for a plurality of spatial streams based on the one or more unequal modulation settings; and
compute, at the AP, one or more constellation sizes for the plurality of spatial streams for transmission to a station (STA) based on the one or more unequal modulation settings; and
a transceiver operable to transmit a transmission using the FEC code rate and the one or more constellation sizes to the STA.

2. The AP of claim 1, wherein the processing device is further operable to:
determine, at the AP, the one or more unequal modulation settings using a signal-to-noise ratio (SNR) measurement received from a sounding packet from the STA.

3. The AP of claim 1, wherein the processing device is further operable to:
determine, at the AP, the one or more unequal modulation settings using a signal-to-noise ratio (SNR) margin feedback from a data packet received from the STA.

4. The AP of claim 1, wherein the processing device is further operable to:
determine, at the AP, the one or more unequal modulation settings using signal-to-noise ratio (SNR) margin feedback and packet error statistics.

5. The AP of claim 1, wherein the FEC code rate is 2/3 and the one or more constellation sizes are one or more of 1 bit, 2 bits, 4 bits, 8 bits, 10 bits, or 12 bits.

6. The AP of claim 1, wherein the processing device is further operable to:
identify, at the AP, the forward error correction (FEC) code rate for a plurality of carriers based on the one or more unequal modulation settings; and
compute, at the AP, the one or more constellation sizes for the plurality of carriers for transmission to a station (STA) based on the one or more unequal modulation settings.

7. The AP of claim 1, wherein the processing device is further operable to:
send, at the AP for transmission to the STA, a modulation order difference in a data packet preamble.

8. A station (STA) comprising:
a processing device operable to:
compute, at the STA, one or more SNR margins for one or more spatial streams; and
send, from the STA to an access point (AP), the SNR margins for the one or more spatial streams.

9. The STA of claim 8, wherein the processing device is further operable to:
compute the one or more SNR margins using receiver error.

10. The STA of claim 8, wherein the processing device is further operable to:
compute the one or more SNR margins using raw bits errors prior to forward error correction (FEC) decoding.

11. The STA of claim 8, wherein the processing device is further operable to:
compute the one or more SNR margins using log likelihood ratio (LLR) statistics.

12. The STA of claim 8, wherein the processing device is further operable to:
compute, at the STA, the one or more SNR margins for one or more carriers.

13. The STA of claim 8, wherein the processing device is further operable to:
receive, at the STA from the AP, a data packet preamble comprising a modulation difference per spatial stream.

14. The STA of claim 8, wherein the processing device is further operable to:
demodulate, at the STA, the one or more spatial streams comprising a plurality of constellation sizes.

15. A method comprising:
computing, at an access point (AP), a forward error correction (FEC) code rate, wherein the FEC code rate is 2/3;
computing, at the AP, a constellation size, wherein the constellation size is one or more of 1 bit, 2 bits, 4 bits, 8 bits, 10 bits, or 12 bits; and
transmitting, from the AP to a STA, a transmission using the FEC code rate and the constellation size.

16. The method of claim 15, further comprising:
sending, at the AP for transmission to the STA, a modulation order difference in a data packet preamble.

17. The method of claim 15, further comprising:
determining, at the AP, one or more unequal modulation settings.

18. The method of claim 17, further comprising:
determining, at the AP, the one or more unequal modulation settings using a signal-to-noise ratio (SNR) measurement received from a sounding packet from the STA.

19. The method of claim 17, further comprising:
determining, at the AP, the one or more unequal modulation settings using a signal-to-noise ratio (SNR) margin feedback from a data packet received from the STA.

20. The method of claim 17, further comprising:
determining, at the AP, the one or more unequal modulation settings using signal-to-noise ratio (SNR) margin feedback and packet error statistics.
